(19) United States
(12) Patent Application Publication
(10) Pub. No.: US 2018/0277826 A1
(43) Pub. Date: Sep. 27, 2018

(54) COMBINATION OF PLASMA COATING AND SPRAY COATING FOR LITHIUM BATTERY ELECTRODE FABRICATION

(71) Applicant: GM GLOBAL TECHNOLOGY OPERATIONS LLC, DETROIT, MI (US)

(72) Inventors: Xiaohong Q. Gayden, West Bloomfield, MI (US); Zhiqiang Yu, Shanghai (CN); Qiang Wu, Shanghai (CN)

(21) Appl. No.: 15/525,111

(22) PCT Filed: Nov. 26, 2014
(86) PCT No.: PCT/CN2014/092255

§ 371 Date: May 8, 2017

(51) Int. Cl. H01M 4/04; H01M 4/139; H01M 4/62; H01M 10/0525; C23C 4/134

(52) U.S. Cl. CPC H01M 4/0419; H01M 4/139; C23C 4/134; H01M 4/625; H01M 10/0525; H01M 4/622

(57) ABSTRACT

An atmospheric plasma spray device is used to direct a stream of plasma-heated, particulate, lithium battery electrode materials to form a porous layer of the electrode particles on a surface of a compatible current collector metal foil. Subsequently, a non-plasma spray device is used to direct a stream of droplets of an aqueous solution of a polymeric binder material onto and into the porous layer of electrode particles. Water evaporates from the droplets of binder solution as the droplets infiltrate the porous electrode material and coat the electrode particles and current collector surface. When the water (or other solvent) has evaporated from the dispersed droplets of polymer material, the polymer binder bonds the particles to each other and to the current collector surface. The polymer spray may immediately follow the deposition of the electrode particles, or follow later, even at a downstream spray location.

### TECHNICAL FIELD

Layered positive and negative electrode members are formed on their respective current collector foils for a lithium battery, such as a lithium-ion battery. An atmospheric plasma spray device is used for applying heated particles of electrode material in a porous layer on the current collector substrate, and then a conventional spray device (non-plasma) is used to deposit a polymeric binder solution to bond the electrode particles to each other and to the substrate.

### BACKGROUND OF THE INVENTION

Assemblies of lithium-ion battery cells and other lithium battery cells, such as lithium-sulfur cells, are finding increasing applications in providing motive power in automotive vehicles. Each lithium-ion cell of the battery is capable of providing an electrical potential of about three to four volts and a direct electrical current, based on the composition and mass of the electrode materials in the cell. The cell is capable of being discharged and re-charged over many cycles. A battery is assembled for an application by combining a suitable number of individual cells in a combination of parallel and series electrical connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

In these automotive applications, each lithium-ion cell typically comprises a negative electrode layer (anode, during cell discharge), a positive electrode layer (cathode, during cell discharge), a thin porous separator layer interposed in face-to-face contact between parallel, facing electrode layers, and a liquid, lithium-containing, electrolyte solution filling the pores of the separator and contacting the facing surfaces of the electrode layers for transport of lithium ions between the electrodes during repeated cell discharging and re-charging cycles. Each electrode is prepared to contain a layer of a porous electrode material, typically deposited as a wet, polymer resin-coated mixture of particles on a thin layer of a metallic current collector.

For example, the negative electrode material has been formed by spreading a thin layer of graphite particles, or of lithium titanate particles, and a suitable polymeric binder onto one or both sides of a thin foil of copper which serves as the current collector for the negative electrode. The positive electrode also comprises a thin layer of resin-bonded, porous, particulate lithium-metal-oxide composition spread on and bonded to a thin foil of aluminum, which serves as the current collector for the positive electrode. Thus, the respective electrodes have been made by dispersing mixtures of the respective binders and active particulate materials in a suitable liquid, depositing the wet mixture as a layer of controlled thickness on the surface of a current collector foil, and drying, pressing, and fixing the resin-bonded electrode particles to their respective current collector surfaces. The positive and negative electrodes may be formed on conductive metal current collector sheets of a suitable area and shape, and cut (if necessary), folded, rolled, or otherwise shaped for assembly into lithium-ion cell containers with suitable porous separators and a liquid electrolyte.

There remains a need for more efficient and economic methods for the making of the respective electrode members of lithium batteries.

### SUMMARY OF THE INVENTION

In many lithium-ion cell designs, a layer of a selected electrode material is deposited on the surface of a sheet or foil of a highly electrically conductive metal such as substantially pure copper or aluminum, or of high electrical conductivity alloys of these metals. In practices of this invention it is desired to suspend particles of electrode material in a stream of air (or other suitable carrier gas), pass the gas stream through a plasma generator to heat the particles in the gas stream, and then to direct the gas-borne, plasma-activated, electrode material particles against the surface of the current collector to deposit and form a uniform layer of the un-bonded electrode particles on the current collector surface.

Following the deposition of the plasma-activated electrode particles, a separate, conventional spray device is employed to deliver a gas-suspended, optionally pre-heated, initially pressurized stream of droplets of a solution of a polymeric binder onto and into the just-deposited, porous layer of electrode particles. Some of the solvent evaporates from the sprayed solution of the polymeric binder as it is discharged from the pressurized spray nozzle into the ambient air, and the rest of the solvent may be evaporated after the droplets of sprayed polymer solution have infiltrated the porous layer of electrode particles. The heat of the plasma-activated electrode particles may promote the evaporation of the solvent. The residual polymer material coats the electrode particles and bonds them to each other and to the surface of the current collector. Again, initial heating of the sprayed solution and residual heat in the electrode particles can promote evaporation of the solvent and spreading of the residual polymeric binder material over the surfaces of the electrode particles and the surface of the current collector. The amount of conventional spray-applied polymeric binder material may be determined by experiment or experience. Typically the residual polymeric bonder will be about 0.1 weight % to about 10 weight % of the weight of binder and electrode particles.

In general, it is preferred to use a water-soluble polymer as a binder such that the water simply evaporates into the ambient air in which the electrode manufacturing process may be conducted. If necessary, the solution may be preheated to a predetermined temperature up to about 90° C. Examples of suitable water-soluble polymers include styrene-butadiene rubber, carboxymethyl cellulose, polyvinyl alcohol, polyethylene oxide, and polypropylene oxide. Of course, other binder polymers and solvents may be used, but the evaporated solvent may have to be suitably removed from the work site.

The binder polymer solution is suspended as droplets in a carrier gas stream (of, for example, air or nitrogen) and directed and sprayed onto a previously deposited porous layer of electrode particles. The droplets of polymer solution may be heated in the carrier gas to promote the gradual evaporation of the water (or other solvent) and to warm the dispersed, residual binder polymer portions for coating the deposited electrode particles and bonding the electrode particles to each other and to the surface of the current collector. Typically, the electrode particles have diameters, or largest representative dimensions, in the range of about one to fifty micrometers, and the dispersed polymeric binder material may be separated into resin bodies or globules of sub-micron to micron sizes.

As stated, the plasma-activated electrode particles are sprayed onto the surface of the current collector substrate and the polymer solution is then sprayed onto the porous layer of electrode particles. The two spraying operations may be done at a single work station with the spray of binder solution droplets closely following (e.g., within a period of a few seconds) the atmospheric plasma spray deposition of the electrode particles. In this embodiment of the invention, the atmospheric plasma spray device and the conventional spray device are supported, coordinated, and directed so as to first form a uniform layer of desired thickness of the porous electrode particles over the selected surface area of the current collector (or other substrate) and immediately (or soon) thereafter directing a suitable amount of the binder solution spray onto and into the porous layer of unbounded electrode material. This practice is illustrated in FIGS. 2A and 2B of the drawings of this specification. In another embodiment of the invention, a layer of electrode material may be deposited onto the selected surface area of a current collector at a first work station. Then, the electrode material coated current collector foil is advanced on a conveyor (or the like) to a second work station at which the polymeric binder solution is spayed on and into the porous layer of electrode material. In this embodiment, the spray pattern for the binder resin application may be larger (or different) from the plasma spray pattern of the electrode particles.

In addition to delivering a solution of polymeric binder onto the electrode material particles, it may also be desired to deliver small electrode-enhancing particles, such as sub-micrometer-size graphite or amorphous carbon particles (electrically conductive carbon particles), for modifying the electrical conductivity or other properties of the electrode material layer of both positive and negative electrodes. Typically the conductive carbon particles may be dispersed in water and/or ethanol (or other water-miscible alcohol) for spraying onto the electrode particles. In situations in which it is suitable to disperse such added particles to the polymer solution, the polymer solution and carbon particles may be sprayed onto the electrode particles using a common spray device for dispersion with the electrode particles. In other applications it may be preferred to suspend the very small conductive carbon particles in their aqueous-alcohol vehicle and apply them from a separate spray device, either before or after the binder solution has been added. When these electrode performance-enhancing carbon particles are added before the binder solution is applied, the binder serves to bond both the electrode particles and the carbon particles to each other. The amount of the carbon particles is suitably up to about three percent by weight of the electrode particles in a lithium-ion cell.

In many lithium battery electrode designs, the metal current collector foil is, for example, rectangular in shape with specified side dimensions depending on the desired sectional configuration of the cell unit. In many cell designs the thickness of the current collector foil or sheet is in the range of about five to twenty five micrometers and the thickness of the applied electrode material is about twenty to two hundred micrometers. The current collector foil may have a connector tab extending from one of its side edges so that it can be electrically connected to other electrode members in the assembly of a cell unit or module of cell units. The particulate electrode material is bonded to one or both sides of the current collector, except for the connector tab.

In a lithium battery manufacturing process many electrode members may be produced in a manufacturing line in which electrode material particles and polymeric binder solution are progressively deposited on surfaces of current collector material.

Other objects and advantages of the invention will be apparent from the following descriptions of illustrative examples of practices of the invention.

### BRIEF DESCRIPTION OF THE DRAWINGS

FIG. 1 is an enlarged, schematic, spaced-apart illustration of the anode, separator, and cathode elements for a representative lithium-ion cell. The anode and cathode each consist of a metal current collector sheet or foil with a porous bonded layer of particulate electrode material.

FIG. 2A is a schematic illustration of an atmospheric plasma spray device for spraying a porous layer of particles of electrode material on a surface of a current collector foil, and of a conventional spray device for subsequently spraying a polymer binder solution onto the particles of electrode material and into the pores between them. The illustration is presented at a fixed moment of time as a conveyor belt carries the current collector foil back and forth past the outlets of the complementary spray devices.

FIG. 2B is an enlarged schematic illustration of the closely spaced locations, at a fixed moment in time, on the surface of the current collector foil of FIG. 2A at which the electrode particle stream from the atmospheric plasma spray device and the spray of the polymer binder solution from the non-plasma spray device are sequentially impacting the surface of the current collector to form a mixture of particles of electrode material and the polymer binder material.

### DESCRIPTION OF PREFERRED EMBODIMENTS

An illustrative lithium-ion cell will be described, in which an electrode member can be prepared using practices of this invention.

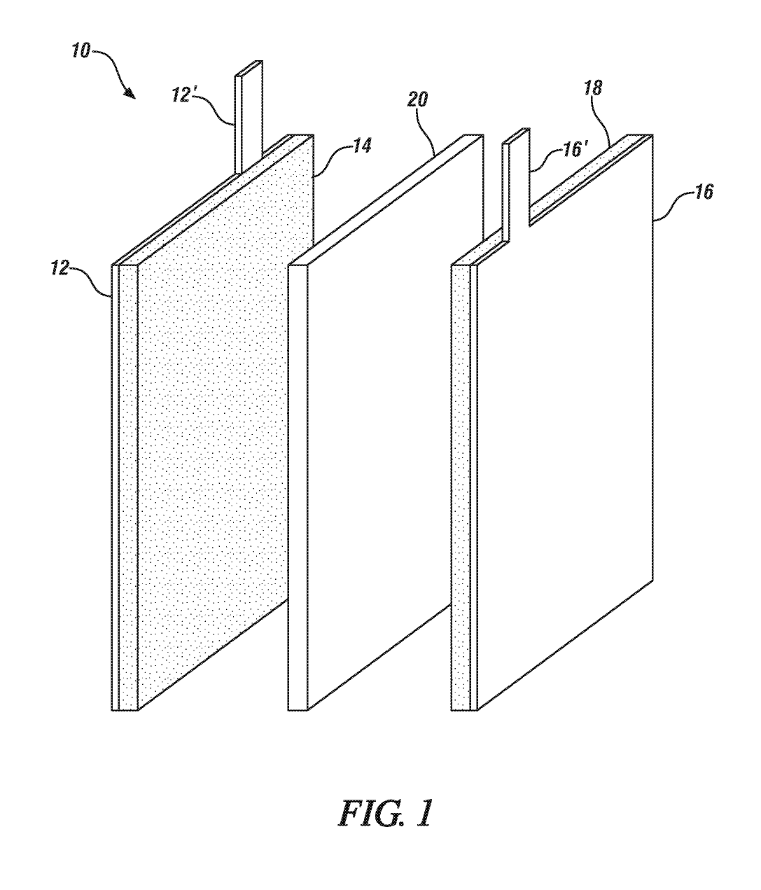

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification. Practices of this invention are typically used to manufacture electrode members of the lithium-ion cell when they are used in the form of relatively thin, layered structures.

In FIG. 1, a negative electrode comprises a relatively thin, electrically conductive, metal foil current collector 12. In many lithium-ion cells, the negative electrode current collector 12 is suitably formed of a thin layer of copper or stainless steel. The thickness of the metal foil current collector is suitably in the range of about five to twenty-five micrometers. The current collector 12 has a desired two-dimensional plan-view shape for assembly with other solid members of a cell. Current collector 12 is illustrated as rectangular over its principal surface, and further provided with a connector tab 12′ for connection with other electrodes in a grouping of lithium-ion cells to provide a desired electrical potential or electrical current flow.

Deposited on the negative electrode current collector 12 is a thin, porous layer of negative electrode material 14. As illustrated in FIG. 1, the layer of negative electrode material 14 is typically co-extensive in shape and area with the main surface of its current collector 12. The electrode material has sufficient porosity to be infiltrated by a liquid, lithium-ion containing electrolyte. The thickness of the rectangular layer of negative electrode material may be up to about two hundred micrometers so as to provide a desired current and power capacity for the negative electrode. As will be further described, the negative electrode material is applied layer-by-layer (e.g., by atmospheric plasma deposition), in combination with a conventional spray deposited quantity of a polymer binder solution, so that one large face of the final block layer of negative electrode material 14 is bonded to a major face of current collector 12 and the other large face of the negative electrode material layer 14 faces outwardly from its current collector 12.

A positive electrode is shown, comprising a positive current collector foil 16 (often formed of aluminum or stainless steel) and a coextensive, overlying, porous deposit of positive electrode material 18. Positive current collector foil 16 also has a connector tab 16′ for electrical connection with other electrodes in other cells that may be packaged together in the assembly of a lithium-ion battery. The positive current collector foil 16 and its coating of porous positive electrode material 18 are typically formed in a size and shape that are complementary to the dimensions of an associated negative electrode. In the illustration of FIG. 1, the two electrodes are alike in their shapes (but they do not have to be identical), and assembled in a lithium-ion cell with the major outer surface of the negative electrode material 14 facing the major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 5 to 25 micrometers. And the thicknesses of the electrode materials, formed by this dry atmospheric plasma process are up to about 200 micrometers. Again, in accordance with practices of this invention, the positive electrode material (or cathode during cell discharge) is formed by an atmospheric plasma deposition method, using an atmospheric plasma spray device, and a complementary spray of polymeric binder solution, to deposit activated particles of cathode material on a metallic current collector foil substrate and to resin-bond them to each other and to the substrate.

As stated above in this specification, and in accordance with practices of this invention, particles of electrode material are deposited on one or both surfaces of a current collector using atmospheric plasma spray devices. Then a solution of a polymeric binder is sequentially deposited (and the solvent evaporated) to suitably bind the electrode particles to each other and to the current collector surface in a suitably porous electrode layer.

A thin porous separator layer 20 is interposed between the major outer face of the negative electrode material layer 14 and the major outer face of the positive electrode material layer 18. The porous separator may be formed of a porous film or of porous interwoven fibers of suitable polymer material, or of ceramic particles, or a polymer material filled with ceramic particles. The porous separator layer is filled with a liquid lithium-ion containing electrolyte and enables the transport of lithium ions between the porous electrode members. But the separator layer 20 is used to prevent direct electrical contact between the negative and positive electrode material layers 14, 18, and is shaped and sized to serve this function.

In prior practices of making the elements of a lithium-ion cell the electrode structures and the separators were formed separately and then combined in the assembly of the cell. In such practices, the opposing major outer faces of the electrode material layers 14, 18 are pressed against the major area faces of the separator membrane 20. A liquid electrolyte is injected into the pores of the separator membrane 20 and the pores of the electrode material layers 14, 18. In preferred practices of this invention, combinations of cell elements may be made using a sequence of atmospheric plasma deposition steps. A finished cell (often of four or five plasma deposited layers) is then suitably packaged, injected with a liquid electrolyte, and further assembled into a desired collection and arrangement of cells for a specified lithium battery. However, this specification focuses on the manufacture of individual positive and negative electrodes comprising a metal current collector with a plasma deposited layer of particles of electrode material which are subsequently polymeric resin-bonded with a co-deposited polymeric binder solution delivered by a non-plasma spray device.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, and propylene carbonate. There are other lithium salts that may be used and other solvents. But a combination of lithium salt and non-aqueous liquid solvent is selected for providing suitable mobility and transport of lithium ions between the opposing electrodes in the operation of the cell. The electrolyte is carefully dispersed into and between closely spaced layers of the electrode elements and separator layers. The electrolyte is not illustrated in the FIG. 1 drawing because it is difficult to illustrate the electrolyte between tightly compacted electrode layers.

In practices of this invention, the electrode members are formed by use of atmospheric plasma spray devices to deposit particles of electrode material onto one or both surfaces of a chemically compatible metal current collector foil. And conventional spray devices are used to sequentially spray and deposit an air-borne stream of droplets of a polymer binder solution for infiltrating and coating the electrode particles, and, upon evaporation of the solvent, bonding the electrode particles to each other and to a current collector surface in a porous electrode layer.

Examples of suitable particulate materials for positive electrodes include lithium manganese nickel cobalt oxide, lithium manganese oxide, lithium cobalt oxide, lithium nickel aluminum cobalt oxide, lithium iron phosphate, and other lithium oxides and phosphates. Examples of particulate negative electrode materials include lithium titanate, graphite and other forms of carbon, and silicon-based materials such as silicon, silicon-based alloys, SiOx, silicon-tin composites, and lithium-silicon alloys.

In general, it is preferred to use water-soluble polymers as spray-deposited binders for the electrode material particles. Examples of suitable water-soluble polymeric binders include styrene-butadiene rubber, carboxymethyl cellulose, polyvinyl alcohol, polyethylene oxide, and polypropylene oxide. Aqueous solutions of one or more of these polymers, with a polymer concentration of about 0.5 to about 5 weight percent of the solution, can be dispersed in a stream of air and applied using a conventional non-plasma spray device. In the use of such a device, the polymer solution is suspended as droplets in a suitably compressed stream of air (or nitrogen or other selected carrier gas) and the polymer solution droplets are carried and directed against the layer of just-deposited plasma-activated electrode materials. If desired, the carrier gas, or the stream of polymer solution droplets, may be heated in the spray device so that, as its solvent is progressively evaporated from the exiting stream of sprayed droplets, the residual, small bodies of polymeric binder material will be suitably softened or melted for subsequent mixing and coating of the electrode particles and for bonding the electrode particles to each other and to the surface of a current collector.

Such non-plasma spray devices are commercially available. They comprise a tube for conduct of carrier gas and suspended droplets of the polymer solution, and a nozzle at the exit end of the tube for directing the stream at a predetermined gas pressure, flow rate, stream cross-sectional area, and flow direction to wet, coat, and bond to the electrode material particles which have previously been deposited on the current collector surface. As stated previously, it may also be desired to suspend submicron-size, conductive carbon particles in water or ethanol so that the suspended particles are carried in a non-plasma spray stream for mixing with the electrode particles to increase their ionic or electrical conductivity or other properties in the electrode structure. A separate non-plasma spray device may be used for adding such electrode performance-enhancing particles when it is not suitable or desired to suspend these particles in the binder solution.

These conventional spray devices may be carried on robot arms or other suitable movable supports and directed under computer control (or the like), for example, to deliver the droplets of a selected polymer solution onto the previously deposited porous layer of electrode particles and to progressively move and direct the stream of polymer binder solution for coating deposited layers of electrode particles on an entire selected surface of the current collector or other substrate.

As stated, the layer of electrode material particles is pre-deposited on a compatible current collector surface using one or more atmospheric plasma nozzles or deposition devices. Such plasma nozzles for this application are commercially available and may also be carried and used on robot arms, under multi-directional computer control, to apply suitable electrode particles to coat the surfaces of each metal current collector foil for a lithium-ion cell module. Multiple nozzles may be required and arranged in such a way that a desired coating speed may be achieved in terms coated area per unit of time.

The atmospheric plasma nozzle typically has a metallic tubular housing which provides a flow path of suitable length for receiving the flow of working gas, receiving and dispersing particles of electrode material, and for enabling the formation of the plasma stream in an electromagnetic field established within the flow path of the tubular housing. The tubular housing terminates in a conically tapered outlet, shaped to direct a suitably shaped plasma stream toward an intended substrate to be coated. An electrically insulating ceramic tube is typically inserted at the inlet of the tubular housing such that it extends along a portion of the flow passage. A stream of a working gas, such as air (or nitrogen or argon), and carrying dispersed particles of a specified electrode material, is introduced into the inlet of the nozzle. The flow of the air-particle mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a suitable generator at a frequency in the 0.1 hertz to gigahertz range and to a suitable potential of a few kilovolts. Plasma generation technology such as corona discharge, radio wave, and microwave sources, and the like, may be employed. The metallic housing of the plasma nozzle is grounded. Thus, an electrical discharge can be generated between the axial pin electrode and the housing. No vacuum chamber is used.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/particulate electrode material stream to the outlet of the nozzle. A reactive plasma of the air (or other carrier gas) and dispersed electrode particles is formed at a relatively low temperature. A copper nozzle at the outlet of the plasma container is shaped to direct the plasma stream in a suitably confined path against the surfaces of the current collector substrates for the lithium-ion cell electrode members. The energy of the plasma may be determined and managed for the material to be applied.

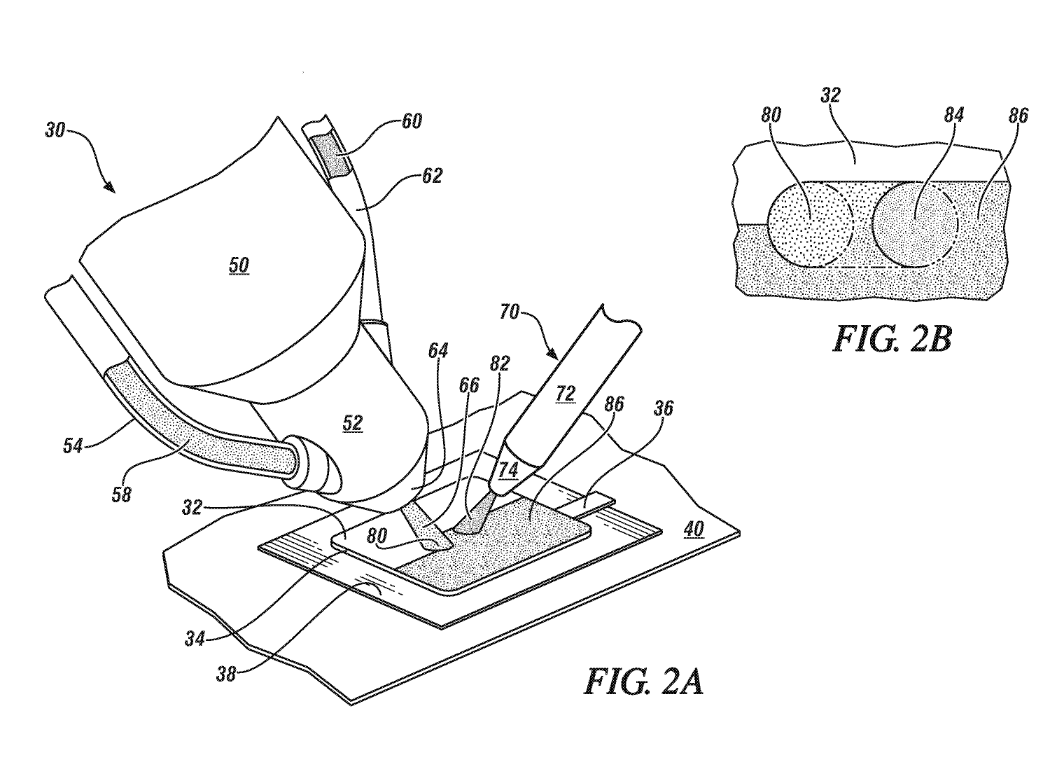

FIG. 2A illustrates the practice of using an atmospheric plasma application device 30 to deposit active electrode material particles in a porous layer of particles on a surface of a metal current collector foil. A conventional spray device 70 is used to spray droplets of an aqueous solution of a polymer binder onto the deposited layer of electrode particles. In this illustrative example, the electrode material is lithium titanate particles as a negative electrode material. The initial aqueous binder solution consists of 5 weight percent styrene butadiene rubber (SBR) and 5 weight percent carboxymethyl cellulose (CMC). The substrate is the upper surface 32 of a copper current collector foil 34. The current collector foil 34 may have a connection tab 36 for connection of a finished electrode to other electrodes in a lithium-ion cell or module of cells. But the connection tab 36 is not coated with the electrode material.

In this example, the current collector foil 34 is placed and carried on a substrate 38, which may be a resin-coated steel foil sized and shaped to serve as a pouch or enclosure material for a finished cell member. Substrate 38 in turn may be carried on a conveyor belt 40, or the like, for locating the current collector foil 34, with its surface 32 under the plasma application device 30 and a conventional spray device 70 for the sequential deposition of particulate electrode material and polymer binder solution on the surface 32. This process may be conducted in air and in a normal ambient workplace atmosphere.

In this example, the copper current collector foil 34 is illustrated in the form of a thin, square layer of about 100 millimeters length on each side, but the cell elements are also often made in other rectangular shapes and dimensions depending on the intended size of the cell elements and assembled cell modules. The copper current collector layer 34 is often about ten to twelve micrometers in thickness. The substrate 38 is moved and placed in a flat position at ambient conditions under a suitable atmospheric plasma spray generator apparatus 30 and a conventional spray device 70, each with a nozzle for directing their respective flow streams. The respective spray devices and/or workpiece may be carried on a suitable support and moved under suitable programmable controls for sequential deposition of particulate electrode material and polymeric binder solution on the surface layer 32 of copper current collector 34.

Atmospheric plasma apparatus 30, for deposition of the negative electrode material, will be described first.

In practices of this invention, and with reference to FIG. 2, an atmospheric plasma apparatus may comprise an upstream round flow chamber 50 (shown partly broken-off in FIG. 2) for the introduction and conduct of a flowing stream of suitable working gas, such as air, nitrogen, or an inert gas such as helium or argon. The flow of the working gas would be introduced above the broken-off illustration of flow chamber 50 and proceed in a downward direction. In this embodiment, this illustrative initial flow chamber 50 is tapered inwardly to smaller round flow chamber 52. Active negative electrode material particles (for example, lithium titanate particles) 58 are delivered through opposing supply tubes 54, 62 into round flow chamber 52. Supply tubes 54, 62 are shown partially broken-away to illustrate delivery of the electrode material particles 58, 60. The electrode material particles are suitably introduced from opposing sides of the apparatus into the working gas stream in chamber 52 and then carried into a plasma nozzle 64 in which the air (or other working gas) is converted to a plasma stream at atmospheric pressure. As the electrode material particles enter the gas stream in chamber 52 they are dispersed and mixed in the stream and carried by it. As the stream flows through the downstream plasma-generator nozzle 64, the electrode material particles are heated by the formed plasma of predetermined and controlled energy to a precursor processing temperature. The momentary thermal impact on the electrode material particles may be a temperature of from about 300° C. up to about 3500° C. The plasma activated electrode material particles exit nozzle 64 as stream 66.

In this example, the stream 66 of air-based plasma and suspended, plasma-activated, electrode material particles (for example, graphite particles or lithium titanate particles) is progressively directed by the nozzle 60 to deposit particles of electrode material 80 onto the surface of the upper surface 32 of the copper foil current collector 34. The nozzle 64 and stream 66 of suspended electrode material is moved in a suitable path and at a suitable rate such that the particulate lithium titanate electrode material 80 is deposited as an unbonded porous layer of specified thickness of the electrode particles on the surface 32 of the current collector foil 34.

Closely following the plasma deposition of the porous particulate lithium titanate electrode material is a spray of droplets of the SBR and CMC solution 82 so as to infiltrate and coat the lithium titanate particles with the SBR/CMC binder material. The spray of aqueous droplets of dissolved SBR/CMC is formed by injecting a prepared solution of the polymer material into an injection port (not illustrated) in conventional spray device 70. The polymer solution is injected into a suitably pressurized stream of air (for example) flowing through the flow cylinder 72 of the spray device. The polymer solution is dispersed as droplets of the polymer solution in flow cylinder 72. The compressed air stream of droplets of polymeric binder solution is released through spray nozzle 74 and enters the lower pressure ambient air. The droplets 82 of polymer solution decrease in size and are directed onto and into the porous layer of lithium titanate particles 80. Some of the water solvent evaporates as the stream leaves nozzle 74 and enters the lower pressure of the atmosphere. The rest of the water solvent evaporates as the now, very small droplets of solution flow onto and coat the plasma-activated particles of lithium titanate and reach the surface 32 of current collector 34. As the solvent evaporates, the residual SBR-CMC material is dispersed over the electrode particles and on the current collector surface and the polymer mixture firms up to bond the lithium titanate particles to each other and to surface 32 of current collector 34. In this process, the temperature of the plasma deposited electrode material and the temperature of the applied spray solution of polymer binder may be determined for suitable removal of the solvent and setting of the dispersed polymer binder material. As stated above, the plasma applied particles of electrode material may have a residual temperature of a few hundred degrees Celsius. And the aqueous solution of the polymer binder may be heated to, e.g., 90° C. or so.

FIG. 2B is an enlarged schematic illustration of the location on current collector surface 32 at which electrode particles 80 have just been deposited from the plasma stream 66. In this region, the electrode particles 80 have not been coated with the polymer binder solution. Region 84 of FIG. 2B illustrates the portion of the plasma deposited electrode particles that have just been infiltrated with spray stream 82 from conventional spray device 70. In region 84 the solvent water may still be evaporating from the applied spray stream. In region 86, the rest of the material illustrated in FIG. 2B, the residual polymeric binder material has set and is bonding the electrode particles.

In the practice of the invention illustrated in FIGS. 2A and 2B the aqueous solution of polymer bonder was applied soon after the particles of electrode material were plasma deposited. In other embodiments of this method, the electrode particles may be applied to the intended surface area of a complementary current collector and the binder polymer solution may be applied subsequently, even at a downstream location in the manufacturing line. One advantage of applying the spray of binder solution droplets at a separate work station is that the area of the polymer spray can be wider and the coverage faster. It is not confined to the approximate area of the plasma spray of the electrode material particles.

The substrate 38, with its newly formed electrode member, consisting of current collector layer 34 and bonded electrode material layer 86, may then be moved to a further processing location. The electrode member may be combined with a separator and an opposing electrode member in the making or assembly of a lithium-ion cell.

Such plasma nozzles 30 and conventional spray devices 70 for this application are commercially available and may be carried and used on robot arms, under multi-directional computer control, to coat the surfaces of each planar substrate for a lithium-ion cell module. Multiple nozzles may be required and arranged in such a way that a high coating speed may be achieved in terms of coated area per unit of time.

While practices of the invention have been described using specific illustrations, the scope of the invention is not limited by these illustrations.

1. A method of making an electrode for a lithium-ion cell, the electrode comprising a metal foil current collector with a porous layer of particulate electrode material bonded to a surface of the metal foil current collector, the method comprising:
forming a stream of electrode material particles suspended in a carrier gas, passing the electrode particles in the gas stream through an atmospheric plasma generator to heat the electrode particles to a predetermined temperature level, directing the plasma activated stream against a portion of the surface of the metal foil current collector, and progressively forming a porous, unbonded layer of electrode particles on a surface area of the metal foil current collector;
separately forming, in a spray device, a stream of drops of a liquid solution of a carbon-based polymer binder material suspended in a carrier gas at a predetermined temperature and above-atmospheric pressure, and, without subjecting the droplets of polymeric binder material to plasma activation, directing the stream of droplets of polymeric binder from the spray device through ambient air onto and into the previously formed, porous, unbonded layer of electrode particles; the gas-borne stream of solution droplets penetrating and coating the particles of the electrode material, such that the solvent is evaporated from the polymeric binder, and residual polymeric binder bonds the electrode particles to each other and to the surface of the metal foil current collector in an electrode for a lithium-ion cell.

2. A method of making an electrode for a lithium-ion cell as stated in claim 1 in which an aqueous solution of the polymer binder is used in bonding the particles of electrode material.

3. A method of making an electrode for a lithium-ion cell as stated in claim 1 in which one or more polymers selected from the group consisting of styrene-butadiene rubber, carboxymethyl cellulose, polyethylene oxide, and polypropylene oxide is dissolved in water and the aqueous solution is used in bonding the particles of electrode material.

4. A method of making an electrode for a lithium-ion cell as stated in claim 2 in which the polymer binder is present in an amount of about one to ten weight percent of the aqueous solution of the polymer binder.

5. A method of making an electrode for a lithium-ion cell as stated in claim 3 in which the polymer binder is present in an amount of about one to ten weight percent of the aqueous solution.

6. A method of making an electrode for a lithium-ion cell as stated in claim 1 in which the polymer binder content is in the range of 0.1 to 10 weight percent by weight of the particles of electrode material and the weight of the residual polymer binder.

7. A method of making an electrode for a lithium-ion cell as stated in claim 1 in which the unbonded plasma-activated electrode particles are applied to the current collector foil at a temperature in the range of 100° C. to 300° C.

8. A method of making an electrode for a lithium-ion cell as stated in claim 1 in which the aqueous polymer binder solution is heated in its spray device to a temperature up to 90° C.

9. A method of making an electrode for a lithium-ion cell as stated in claim 1 in which the droplets of binder solution are deposited onto the unbonded electrode particles at the same site as the unbonded electrode particles are applied immediately following the deposit on the unbonded electrode materials.

10. A method of making an electrode for a lithium-ion cell as stated in claim 1 in which the droplets of binder polymer solution are applied to the unbonded electrode material particles after completion of the deposit of the electrode particles on a surface of a metal foil current collector.

11. A method of making an electrode for a lithium-ion cell as stated in claim 1 in which the electrode material is particles of active negative electrode material and the metal current collector foil is a metal that is electrically compatible with the negative electrode material.

12. A method of making an electrode for a lithium-ion cell as stated in claim 1 in which the electrode material is particles of active positive electrode material and the metal current collector foil is a metal that is electrically compatible with the positive electrode material.

13. A method of making an electrode for a lithium-ion cell as stated in claim 1 in which the electrode material is particles of active negative electrode material and the metal current collector foil is a metal that is electrically compatible with the negative electrode material and the thickness of the current collector foil is about eight to twenty-five micrometers and the thickness of the deposited negative electrode layer is in the range of twenty to two hundred micrometers.

14. A method of making an electrode for a lithium-ion cell as stated in claim 1 in which the electrode material is particles of active positive electrode material and the metal current collector foil is a metal that is electrically compatible with the positive electrode material and the thickness of the current collector foil is about eight to twenty-five micrometers and the thickness of the deposited positive electrode layer is in the range of twenty to two hundred micrometers.

15. A method of making an electrode for a lithium-ion cell as stated in claim 1 in which sub-micrometer size conductive carbon particles, selected for improving the electrochemical performance of the electrode material in the cell, are dispersed in a liquid vehicle and the dispersion sprayed onto and into the porous, layer of electrode particles.

16. A method of making an electrode for a lithium-ion cell as stated in claim 15 in which the conductive carbon particles are dispersed in water or an alcohol that is miscible with water and the weight of the conductive carbon particles is up to about three percent of the weight of the electrode particles.

17. A method of making an electrode for a lithium-ion cell as stated in claim 15 in which the dispersion of conductive carbon particles is sprayed onto and into the layer of electrode particles separately from the stream of droplets of the polymeric binder.

18. A method of making an electrode for a lithium-ion cell as stated in claim 15 in which the conductive carbon particles are dispersed in the liquid solution of a carbon-based polymer binder material and applied with the polymer binder material onto and into the previously formed layer of electrode particles.

19. A method of making an electrode for a lithium-ion cell, the electrode comprising a metal foil current collector with a porous layer of particulate electrode material bonded to a surface of the metal foil current collector, the method comprising:
forming a stream of electrode material particles suspended in a carrier gas, passing the electrode particles in the gas stream through an atmospheric plasma generator to heat the electrode particles to a predetermined temperature level, directing the plasma activated stream against a portion of the surface of the metal foil current collector, and progressively forming a porous, unbonded layer of electrode particles on a surface area of the metal foil current collector;
separately forming, in a first spray device, a stream of droplets of particles of sub-micron size conductive carbon particles dispersed in a liquid vehicle comprising water, the droplets being suspended in a carrier gas at a predetermined temperature and above-atmospheric pressure, and, without subjecting the droplets of dispersed carbon particles to plasma activation, directing the stream of droplets of particles of dispersed conductive carbon particles from the spray device through ambient air onto and into the previously formed, porous, unbonded layer of electrode particles; the gas-borne stream of droplets penetrating and coating the particles of the electrode material, such that the liquid vehicle is evaporated from the conductive carbon particles they infiltrate into pores between the electrode particles and coat the electrode particles;
separately forming, in a spray device, a stream of drops of a liquid solution of a carbon-based polymer binder material suspended in a carrier gas at a predetermined temperature and above-atmospheric pressure, and, without subjecting the droplets of polymeric binder material to plasma activation, directing the stream of droplets of polymeric binder from the spray device through ambient air onto and into the previously formed, porous, unbonded layer of electrode particles; the gas-borne stream of solution droplets penetrating and coating the particles of the electrode material and the particles of electrode-enhancing material, such that the solvent is evaporated from the polymeric binder, and residual polymeric binder bonds the electrode particles to each other and to the surface of the metal foil current collector in an electrode for a lithium-ion cell.

20. A method of making an electrode for a lithium-ion cell as stated in claim 19 in which the conductive carbon particles are dispersed in water or an alcohol that is miscible with water, and the weight of the carbon particles is up to about three percent of the weight of the electrode particles.
